(19) United States
(12) Patent Application Publication
(10) Pub. No.: US 2002/0082894 A1
(43) Pub. Date: Jun. 27, 2002

(54) Business information system and method of managing business information

(75) Inventor: Tomihiko Azuma, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/003,383

(22) Filed: Dec. 6, 2001

(30) Foreign Application Priority Data
Dec. 19, 2000 (JP) 2000-385410

(51) Int. Cl. G06F 17/60

(52) U.S. Cl. 705/8

(57) ABSTRACT

Provision of organization definition information storing unit for storing organization definition information for defining an organization, organization definition information registering means for storing the input organization definition information in the organization definition information storing unit, and information-distribution controlling means for receiving a message originated by an input originator and a condition for recipient of message designated by the use of arbitrary organization definition information, for retrieving the organization definition information storing unit by the use of the condition for recipient of message, and for acquiring, when an recipient of message who satisfies the condition for recipient is detected, address information of the recipient from the organization definition information storing unit to thereby distribute the message.

### BACKGROUND OF THE INVENTION

1. Field of the Invention

The present invention relates to a business information system and a method of managing business information, suitable for managing internal information of an enterprise in the enterprise.

2. Description of the Related Art

In the business information system according to the prior art, an originator of the information has specified a recipient of the information by specifying information such as an electronic mail (E-mail) address. Also, when given information in block should be sent to a plurality of recipients, mailing list in which mail addresses of a plurality of recipients are gathered together has been effectively used.

An example of the above described prior art is disclosed in National Publication of Translated Version (Kohyo) No. WO98/00786 entitled “Work Flow System”. The prior art disclosed in this National Publication is featured in that, in a document circulating system, which needs to predetermine a circulating route such as a workflow, objective persons to be processed are grouped together in a concept of a roll, and further by the use of organization definition information as a condition of the group, any adverse affect given on the circulating route at the time of occurrence of the changes of personnel is eliminated insofar as is possible. That is to say, it is necessary that the conditions for workers covering the processing are preliminarily made as the roll definition information.

However, the conditions that can be used from the organization definition information for designating the workers for the processing are limited to the post information, the office organization information, and the office organization extent. Further, the user definition information of the workflow is limited to the post and the office organization, and therefore it has no concept of an employee. Thus, the user definition information is not dealt with by the entire organization definition information of an enterprise or a corporation.

Nevertheless, the above-described prior art has encountered the following problems.

The business information system is a system for assisting each individual to execute jobs in an enterprise, and has close relationship with the occupational position, the affiliation, and the covering jobs of the individuals. However, in the conventional business system, the effective use of the organization definition information as the controlling information for the distribution of information is insufficient, and since the transmission of information must be executed by designating the address information such as the E-mail address or addresses, there have occurred problems such that the transmission of the necessary information is delayed, unnecessary information is erroneously transmitted, and cost must be incurred for individually retrieving the information of the addresses of the recipients.

Further, as information is sent in block to a plurality of recipients, in the business information system employing the mailing list of the E-mail addresses, at the time when the changes of personnel as well as the change in the organization occurs, the mailing list receiving any effect from these changes must be corrected, and accordingly a problem occurs in which an extensive amount of cost must be incurred for the correction.

### SUMMARY OF THE INVENTION

An object of the present invention is to provide a business information system and a method of managing business information, capable of solving the above problems, and more specifically, to provide a business information system and a method of managing business information by which necessary information may be surely distributed without any leakage when controlling for distribution of information is executed on the basis of organization definition information.

To solve the above problems, the present invention is characterized in that there are provided an organization definition information storing unit for storing organization definition information for defining an organization, an organization definition information registering means storing input organization definition information in the organization definition information storing unit, and an information-distribution controlling means for receiving a message originated by an input originator and a condition for recipient of massage, which is designated by arbitrary organization definition information stored in the organization definition information storing unit, for retrieving the organization definition information storing means by the use of the condition for recipient of message, and for acquiring, upon detection of a recipient of the message who satisfies the condition for recipient of message, address information of the recipient from the organization definition information storing unit to thereby distribute the message. Also, the present invention is characterized in that the information-distribution controlling means retrieves the organization definition information storing unit by the use of the condition for recipient of message, and upon failing in detection of the recipient of the message, displays on an output device of the originator that the corresponding recipient does not exist.

Further, the present invention is characterized in that the address information includes any one of an E-mail address, a telephone number, a facsimile number, and address.

Furthermore, the present invention is characterized in that the organization definition information is constituted by including information representing at least one of organization hierarchy, information representing partial organization, information representing distribution of personnel, and information concerning job of each individual.

A still further, the present invention is characterized in that the information concerning the job of each individual is constituted by including information representing at least one of employee identification number, name, occupational position, covering job, function, duty, knowledge, experience, and location.

Furthermore, the present invention is characterized in that the organization definition information storing unit stores authentication information indicating that each individual is a true user of the business information system, and that at least of the organization definition information registering means and the information-distribution controlling means executes the afore-mentioned processing on the basis of the authentication information of an input user only when the user is a true user of the business information system.

Further, the present invention is characterized in that the above-mentioned condition for recipient of message is capable of being defined by a complex condition made by combining a plurality of conditions.

Furthermore, the present invention is characterized by comprising, by the use of organization definition information storing unit for storing organization definition information for defining an organization, an organization definition information registering step for storing input organization definition information in the organization definition information storing unit, and an information-distribution controlling step for receiving a message originated by an input originator and a condition for recipient of massage, which is designated by arbitrary organization definition information stored in the organization definition information storing unit, for retrieving the organization definition information storing unit by the use of the condition for recipient of message, and for acquiring, upon detection of a recipient of the message who satisfies the condition for the recipient of message, address information of the recipient from the organization definition information storing unit to thereby distribute the message.

The present invention provides the following advantageous effects.

The first advantageous effect of the present invention resides in that accuracy in the distribution of information in the business information system can be enhanced so that occurrence of problems such as an escape in the transmission of necessary information and erroneous transmission of unnecessary information may be prevented while enabling it to reduce cost for the distribution of information.

The reason for the above effect is because the distribution of information in the business information system is managed on the basis of the organization definition such as the upper and lower relationship formed by a boss and subordinates (relative relationship among occupational positions), a position on the organization hierarchy, a condition concerning attribute value constituting the occupational definition of an individual. The originator of information does not directly use any address information such as E-mail address of a recipient of information as information for specifying the recipient of information. Namely, the originator of information specifies a recipient of information for the business information system by the use of only the upper and lower relationship formed by the boss and subordinates, the position on the organization hierarchy, and the condition concerning the attribute value constituting the occupational definition of an individual, and a complex condition formed by combining the above, and the business information system automatically acquires the address information of any recipient to utilize it for the transmission of information. Hereunder, the originator of information is not requested to individually investigate address information of the recipient of information.

The second advantageous effect of the present invention resides in that cost incurred for the revision of controlling information of the distribution of information accompanying by personnel changes and a change in the organization may be extensively reduced.

The reason for the second effect is because the organization definition information that the personnel division manages as controlling information of information-distribution is directly utilized. When the personnel changes and the change in the organization occur, only revision of the organization definition information by e.g., the personnel division will immediately make it valid to execute the controlling of the distribution of information.

### BRIEF DESCRIPTION OF THE DRAWINGS

FIG. 1 is a block diagram illustrating a construction of a business information system according to an embodiment of the present invention;

FIG. 2 is a diagrammatic view illustrating an example of the construction of organization definition information stored in the organization definition information storing unit of FIG. 1;

FIG. 3 is a tree diagram illustrating an example of information concerning organization hierarchy and distribution of personnel stored in the organization definition information storing unit of FIG. 1;

FIG. 4 is a diagrammatic view illustrating an example of personal information stored in the organization definition information storing unit of FIG. 1;

FIG. 5 is a view illustrating an example representing the organization definition information of FIGS. 3 and 4 in extensible markup language (XML);

FIG. 6 is a diagrammatic view illustrating a definition concerning a tag set of the XML shown in FIG. 5;

FIG. 7 is a view illustrating the construction of the XML document of FIG. 5;

FIG. 8 is a view illustrating an example in which the organization definition information of FIGS. 3 and 4 is represented by a directory tree of lightweight directory access protocol (LDAP) server;

FIG. 9 is a view illustrating an example in which the directory tree of FIG. 8 is represented all over again in the LDAP data interchange format (LDIF);

FIG. 10 is a view indicating a definition concerning the attribute of LDAP used in FIGS. 8 and 9;

FIG. 11 is a view illustrating an example in which the organization definition information of FIGS. 3 and 4 is represented by the style of a table, and table (1) of FIG. 11 being a representation of the organization construction of “Company AB”, and table (2) of FIG. 11 being a representation of distribution of personnel and personal information;

FIG. 12 is a flowchart illustrating the operation of distribution of a message from an originator to an appropriate recipient on the basis of the organization definition in the construction of FIG. 1;

FIG. 13 is a view illustrating an example of a display indicated on the screen of the output device when an originator originates information by the use of the input device of FIG. 1;

FIG. 14 is an explanatory view illustrating the controlling for information-distribution when an employee of “Company AB” executes originating of information by the use of the display of FIG. 13;

FIG. 15 is a view illustrating an example of a display indicated on the output device when an originator executes originating of information by the use of the input device of FIG. 1, the example displaying a case where a condition for a recipient of message designates “a direct boss”;

FIG. 16 is an explanatory view illustrating the controlling for information-distribution when an employee of “Company AB” executes originating of information by the use of the display of FIG. 15;

FIG. 17 a view illustrating an example of a display indicated on the output device when an originator executes originating of information by the use of the input device of FIG. 1, the example displaying a case where a condition for a recipient of message designates “whole of the organization”;

FIG. 18 is an explanatory view illustrating the controlling for information-distribution when an employee of “Company AB” executes originating of information by the use of the display of FIG. 17;

FIG. 19 is a view illustrating an example of a display indicated on the output device when an originator executes originating of information by the use of the input device of FIG. 1, the example displaying a case where a condition for a recipient of message designates “occupational position=chief of department”;

FIG. 20 is a view illustrating an example of a display indicated on the output device when an originator executes originating of information by the use of the input device of FIG. 1, the example displaying a case where a condition for a recipient of message designates “covering job=video and category of occupation=development”;

FIG. 21 is a view illustrating an example in which revision of organization is reflected against the organization definition information of table (1) of FIG. 11;

FIG. 22 is a view illustrating an example in which revision of organization and changes of personnel are reflected against the organization definition information of table (2) of FIG. 11; and,

FIG. 23 is an explanatory view illustrating controlling for information-distribution for the organization definition shown in FIGS. 21 and 22 in a case where a condition for a recipient of message designates “direct subordinates”.

The above and other objects, features, and advantages of the present invention will become apparent from the following description based on the accompanying drawings which illustrate examples of preferred embodiments of the present invention.

### DETAILED DESCRIPTIONN OF THE PREFERRED EMBODIMENTS

Description of a business information system according to an embodiment of the present invention will be provided hereinbelow with reference to the accompanying drawings.

[The Construction of the Embodiment]

Referring to FIG. 1, the present embodiment of the present invention includes input device 1 constituted by a keyboard of a personal computer, a portable telephone, an operating unit of portable information terminal and so on, data processing device 2 operating under program control, storage device 3 for storing information, and output device 4 constituted by a displaying device of a personal computer, a portable telephone, a displaying unit of a portable information terminal and so on. Data processing device 2 is connected to input device 1 and output device 4 by wire or radio, and the connection may include a case where these devices are connected by a network of the Internet.

Storage device 3 is provided with organization definition information storing unit 31 in which the entire information of an organization such as organization hierarchy, partial organization, and distribution of personnel, personal information such as employee ID of individuals (employee identification code), names, occupational positions, category of occupations, covering jobs, functions, knowledge, and locations, and passwords used as authentication information when an individual uses the business information system are stored.

Data processing device 2 is provided with organization definition information registering means 21 accommodating respective functions realized by the program control, respectively, and information-distribution controlling means 22.

Organization definition information registering means 21 receives from input device 1 the entire information of an organization such as organization hierarchy, partial organization, and distribution of personnel, personal information such as employee ID of individuals, names, occupational positions, category of occupations, covering jobs, functions, knowledge, and locations, and passwords used as authentication information when an individual uses the business information system, and stores them in organization definition information storing unit 31.

Information-distribution controlling means 22 receives from input device 1 the employee ID and a password as authentication information of an originator of information, and after confirming that the originator is a true user of the business information system, and receives a message originated by the originator and a condition for recipient of message designated by the use of arbitrary organization definition information stored in organization definition information storing unit 31 via input device 1. Information-distribution controlling means 22 retrieves organization definition information storing unit 31 by the use of the condition for recipient of information, and upon detection of the recipient of message, acquires address information of the recipient from organization definition information storing unit 31 to distribute the message. The address information used for distributing of the message may be an E-mail address, a telephone number, facsimile number, and address. Upon failing in detection of the recipient of the message, displaying is executed on output device 4 of the originator to indicate that the corresponding recipient does not exist.

[The Operation of the Embodiment]

The operation of the present embodiment will be described in detail hereinafter with reference to FIGS. 1, 2, 3, 4, 5, 6, 7, 8, 9, 10, 11, 12, 13, 14, 15, 16, 17, 18, 19, 20, 21, 22 and 23.

Now, the concrete content of the organization definition information will be described in detail with reference to FIGS. 1, 2, 3, 4, 5, 6, 7, 8, 9, 10 and 11.

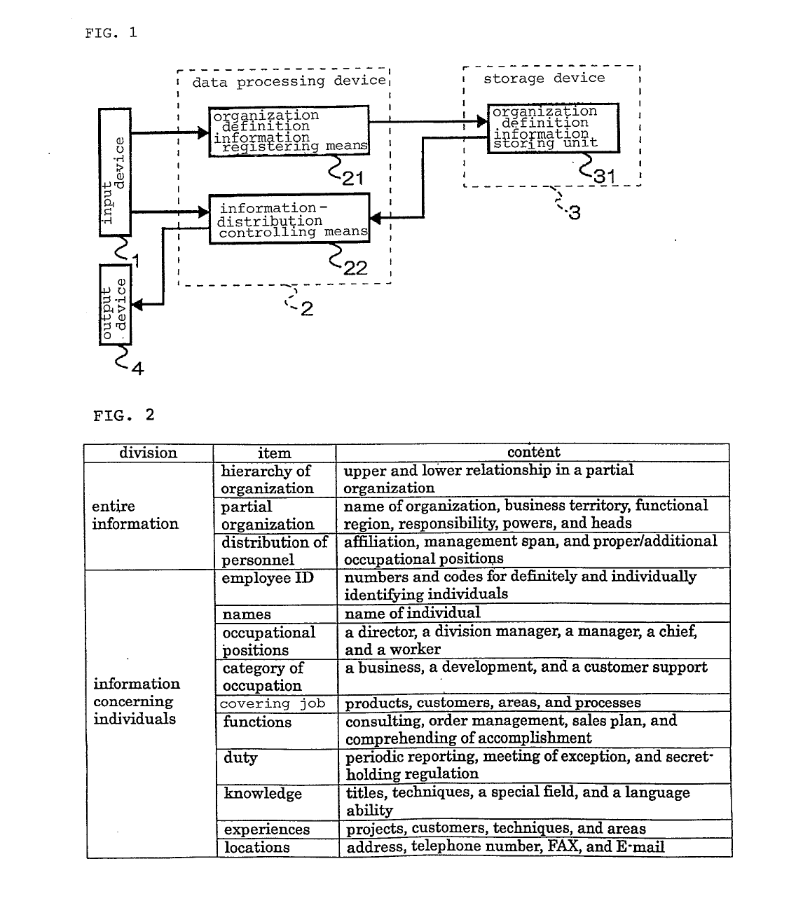

FIG. 2 is a view of a constructional example of the organization definition information stored in organization definition information storing unit 31 in the business information system according to the present invention, illustrating that the information is partitioned into three categories, i.e., division, item and content. Referring to FIG. 2, the whole information representing a total definition of the organization is constituted by information concerning organization hierarchy representing the upper and lower relationship in the partial organization, information concerning the partial organization, which is e.g., a business division and a division provided for every business territory and every functional region, and information concerning the distribution of personnel in the whole of the organization. Information concerning individuals subordinate to the organization is constituted by employee ID, which are used for individually identifying every individual, names of individuals, information concerning occupational positions such as a division managers, and a department chief, information concerning category of occupation such as business and development, information concerning covering job such as products and customers, information concerning function to be executed as duties, information concerning the duty to be accomplished in the organization, information concerning knowledge such as qualifications and techniques of individuals, information concerning experience such as the projects and customers covered in the past, and information concerning location such as telephone numbers and E-mail addresses.

In the example shown in FIG. 2, the information concerning the partial organization includes information representing the name of organization, the business territory, the functional region, the responsibility, the authority, and the head, and the information concerning the distribution of personnel is constructed to include information representing the affiliation, the management span, and the proper/additional occupational positions.

In the information concerning the individuals, the employee ID includes information representing the number and code individually identifying an individual, the information concerning the occupational position includes information representing the director, the division manager, the manager, the chief, and the worker, the information concerning the category of occupation includes information representing the business, the development, and the customer support, the information concerning the covering job includes information representing the product, the customer, the area, and the process, the information concerning the function includes information representing the consulting, the order management, the sales scheme, and the comprehending of accomplishment, the information concerning the duty includes information representing the periodic reporting, the dealing with exceptions, and the regulation for keeping secrets, the information concerning the knowledge includes information representing the qualification, the technique, the special field, and the language ability, the information concerning the experience includes information representing the projects, the customers, the technique, and the area, and the information concerning the location includes information representing the address, the telephone number, the FAX, and the E-mail.

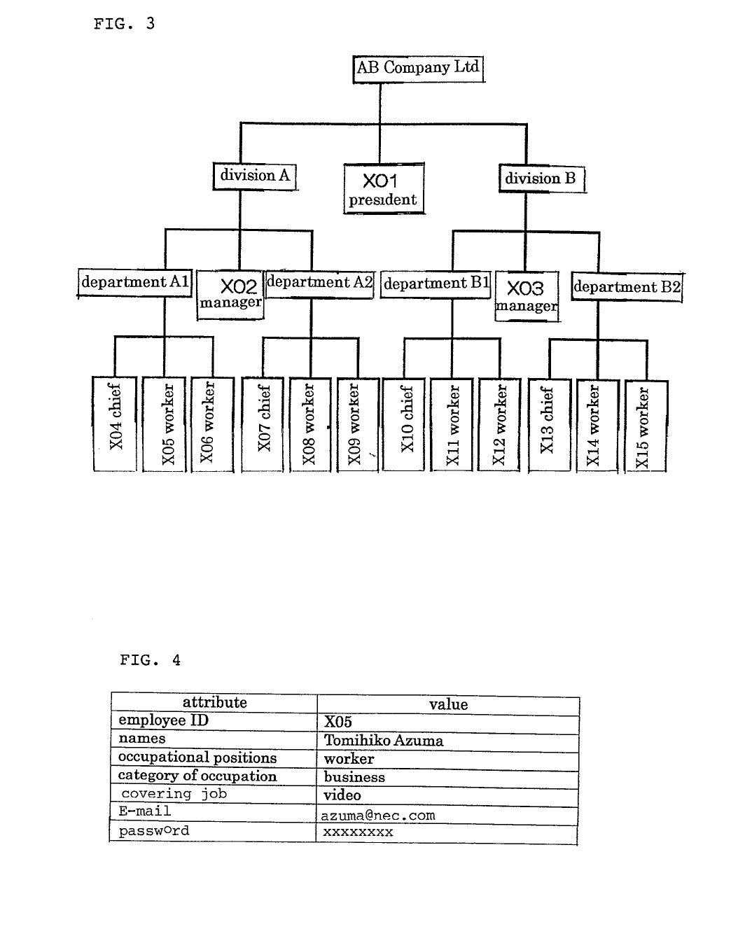

FIG. 3 is an example of the information concerning the organization hierarchy and the distribution of personnel stored in organization definition information storing unit 31, and illustrates the organization hierarchy of the enterprise stating, “Company AB” in a reverse tree fashion, so that the upper and lower positional relationship in the drawing represents the upper and lower relationship in the organization hierarchy. From FIG. 3, it will be understood that “Company AB” is constituted by “Division A” and “Division B”, “Division A” is constituted by “Department A1” and “Department A2”, and “Division B” is constituted by “Department B1” and “Department B2”. Further, in FIG. 3, as the head of “Company AB”, a person having the employee ID of “X01” is assigned to the occupational position of the president, and as the heads of “Division A” and “Division B”, persons “X02” and “X03” are assigned to the occupational position of the manager, respectively. Similarly, as the heads of “Department A1”, “Department A2”, “Department B1” and “Department B2”, persons “X04”, “X07”, “X10”, and “X13” are assigned to the occupational position of “chief”, respectively. Persons “X05” and “X06” whose occupational position is a worker, respectively, belong to “Department A1”, and persons “X08” and “X09” belong to “Department A2”, persons “X11” and “X12” belong to “Department B1”, and persons “X14” and “X15” belong to “Department B2”.

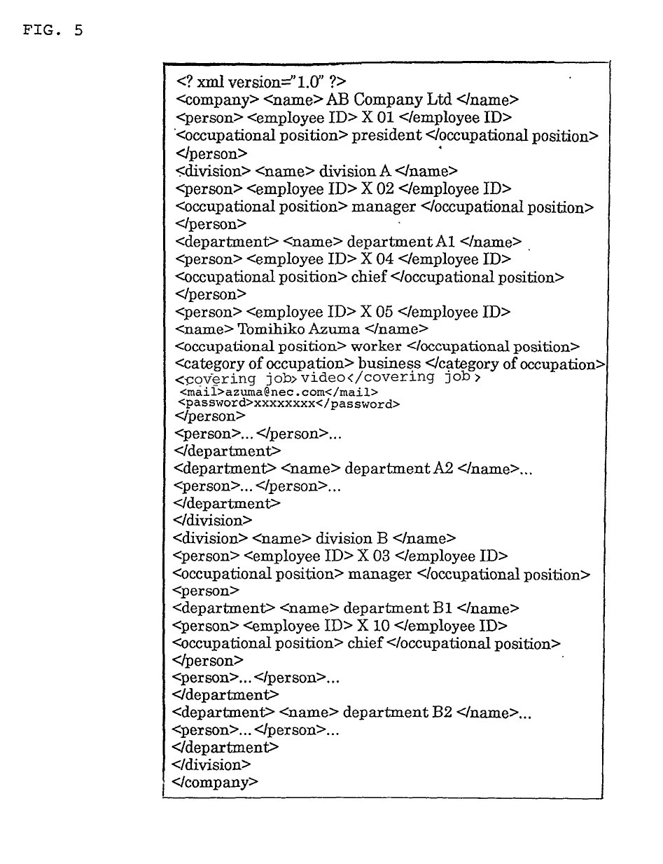

FIG. 4 illustrates an example of the information of individuals stored in organization definition information storing unit 31. In FIG. 4, as the attribute of the information of individuals, the employee ID (“X05”), the name (“Tomihiko Azuma”), the occupational position (“worker”), the category of occupation (“business”), the covering job (“video”) and the E-mail address (“azuma@nec.com”) are stored, and simultaneously, a password is also stored as authentication information of a user.

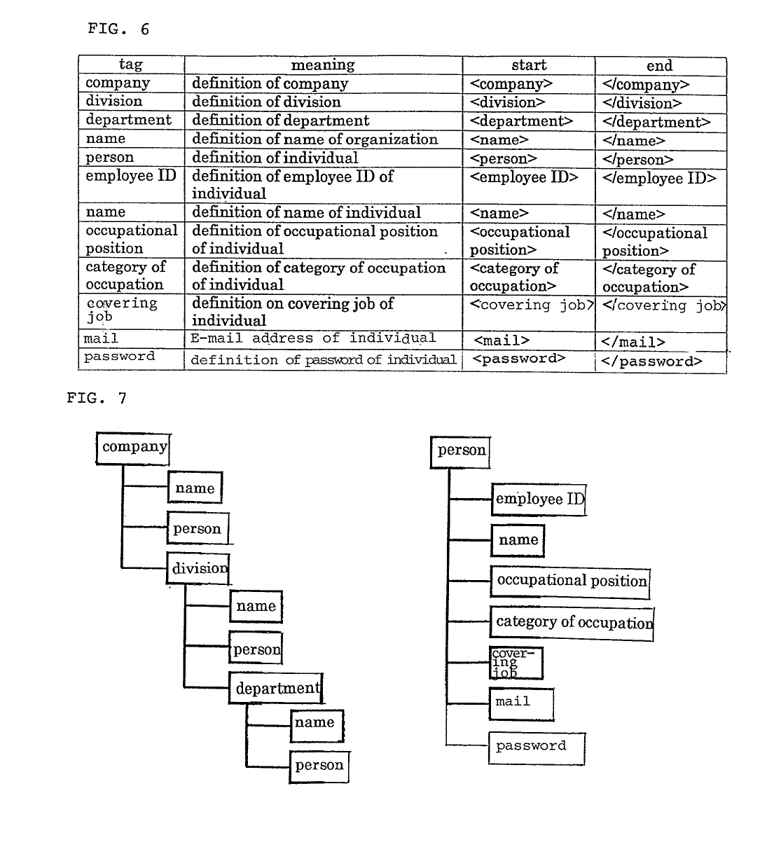

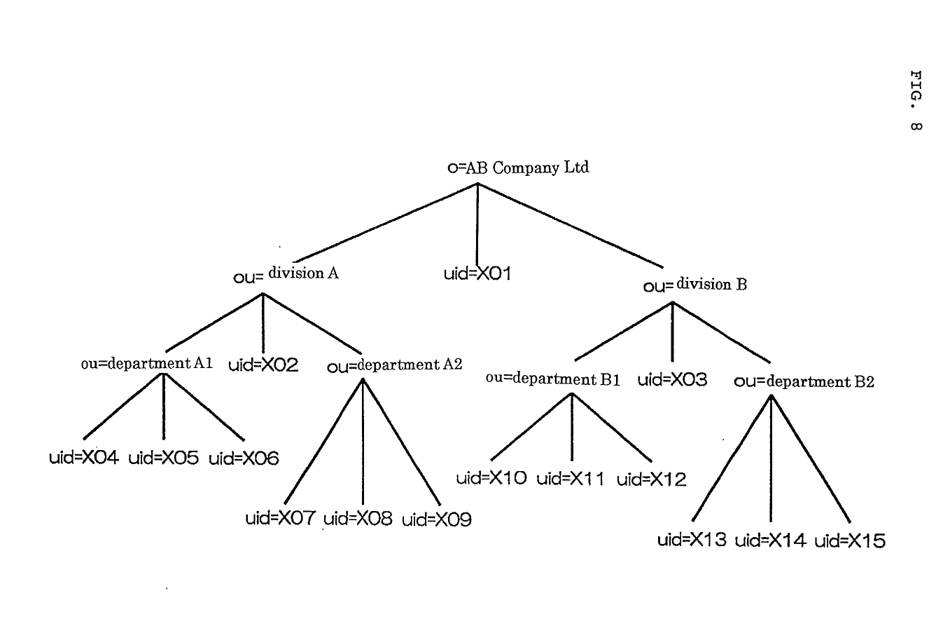

FIG. 5 is an example in which the organization definition information of FIGS. 3 and 4 is represented in XML (Extensible Markup language). FIG. 6 is the definition concerning the tag set of the XML used in FIG. 5. Due to the definition of FIG. 6, in FIG. 5, the definition concerning the company is defined in a region enclosed by <company> and </company>, similarly, the definition concerning the division is defined in a region enclosed by <division> and </division>, the definition concerning the department is defined in a region enclosed by <department> and </department>, and the definition concerning the name of the organization is defined in a region enclosed by <name> and </name>. Similarly, the definition concerning the individuals is defined in a region enclosed by <person> and </person> , the definition concerning the employee ID of an, individual is defined in a region enclosed by <employee ID> and </employee ID>, the definition concerning the name of an individual is defined in a region enclosed by <name> and </name>, the definition concerning the occupational position of an individual is defined in a region enclosed by <occupational position> and </occupational position>, the definition concerning the category of occupation of an individual is defined in a region enclosed by <category of occupation> and </category of occupation>, the definition concerning the covering job of an individual is defined in a region enclosed by <covering job> and </ covering job>, the definition concerning the E-mail address of an individual is defined in a region enclosed by <mail> and </mail>, and the definition concerning the password of an individual is defined in a region enclosed by <password> and </password>.

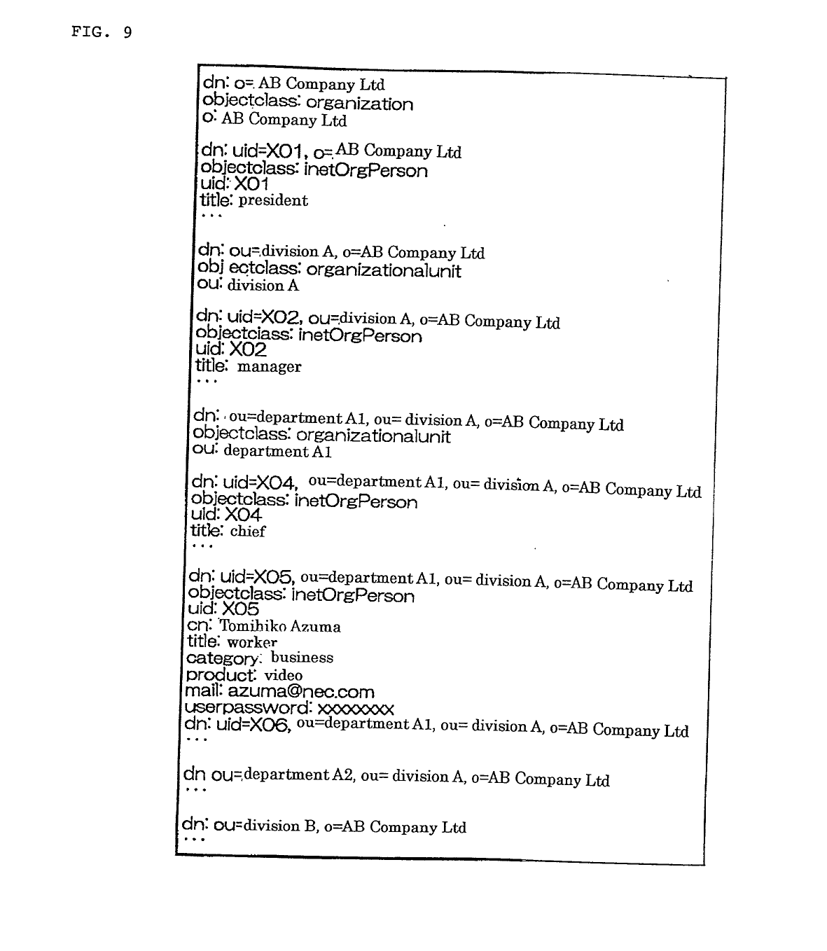

FIG. 7 is a view indicating the construction of the XML document of FIG. 5. In the example shown in FIG. 7, the element indicated by the tag “company” includes respective elements indicated by the tags “name”, “person”, and “division”, the element indicated by the tag “division” includes respective elements indicated by the tags “name”, “person”, and “department”, and the element indicated by the tag “department” includes respective elements indicated by the tags “name”, and “person”. Also, the element indicated by the tag “person” includes respective elements indicated by the tags “employee ID”, “name”, “occupational position”, “category of occupation”, “covering job”, “mail”, and “password”.

In FIG. 5, the information concerning the upper and lower relationship and the distribution of personnel is represented by the class inclusion relationship, according to the construction definition of FIG. 7. For example, between <company> and </company> which represents the definition of “Company AB”, there are included a region enclosed by <person> and </person> which represent the president, a region enclosed by <division> and </division> which represent “Division A”, and a region enclosed by division> and </division> which represent “Division B”. Hereunder, it is represented that the president of “Company AB” is “X01”, and “Division A” and “Division B” constitute “Company AB”. Similarly, between <division> and </division> which represent the definition of “Division A”, there are included two regions, i.e., a region enclosed by <person> and </person> which represent “X02” who is a manager, and a region enclosed by <department> and </department> which represent the definition of “Department A1”, “Department A2”. Further, between <division> and </division> which represent the definition of “Division B”, there are included two regions, i.e., a region enclosed by <person> and </person> which represent “X03” who is a manager, and a region enclosed by <department> and </department> which represent the definition of “Department B1” and “Department B2”. Between <department> and </department> which represent the definition of “Department A1”, there are included a plurality of regions enclosed by <person> and </person> which represent the definition of the chief and workers so as to represent the distribution of personnel in “Department A1”.

Figure illustrates an example in which the organization definition information of FIGS. 3 and 4 is represented by a directory tree of a LDAP (Lightweight Directory Access Protocol) server. In FIG. 8, the company is represented by identification data stating, “ou=Division A”, and the partial organization such as the division and the department is represented by identification data stating, “ou=Division A” and “ou=Department A1”. Concerning a person, it is represented by “uid=X01” which employs the employee ID.

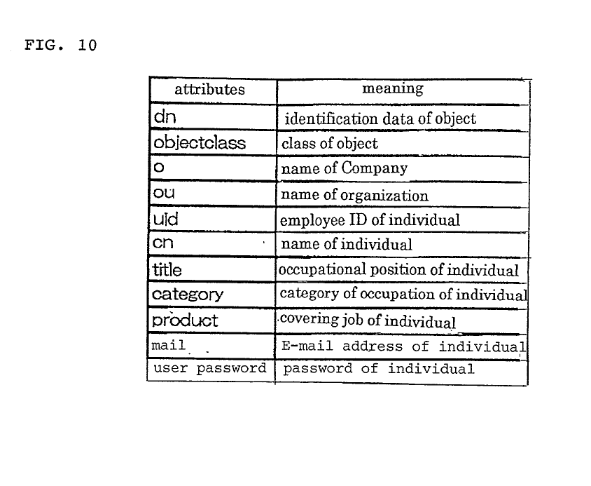

FIG. 9 is an example in which in order to explain the organization definition information for the individuals of which the explanation is omitted in FIG. 8, the directory tree of FIG. 8 is represented all over again in the LDIF (LDAP Data Interchange Format). In FIG. 9, the organization definition information for the individuals of which the explanation is omitted in FIG. 8 is defined by the attribute such as “cn”, “title”, “category”, “product”, and “userpassword”.

FIG. 10 is the definition concerning the attribute of the LDAP used in FIGS. 8 and 9. In this case, the attribute “dh” represents “identification data of object”, the attribute “objectclass” represents “class of object”, the attribute “o” represents “the name of the company”, the attribute “ou” represents “the name of the organization”, the attribute “uid” represents “the employee ID of an Individual”, the attribute “cn” represents “the name of an individual”, the attribute “title” represents “the occupational position of an individual”, the attribute “category” represents “the category of occupation of an individual”, the attribute “product” represents “the covering of job of an individual”, the attribute “mail” represents “the electronic mail address of an individual”, and the attribute “userpassword” represents “the password of an individual”.

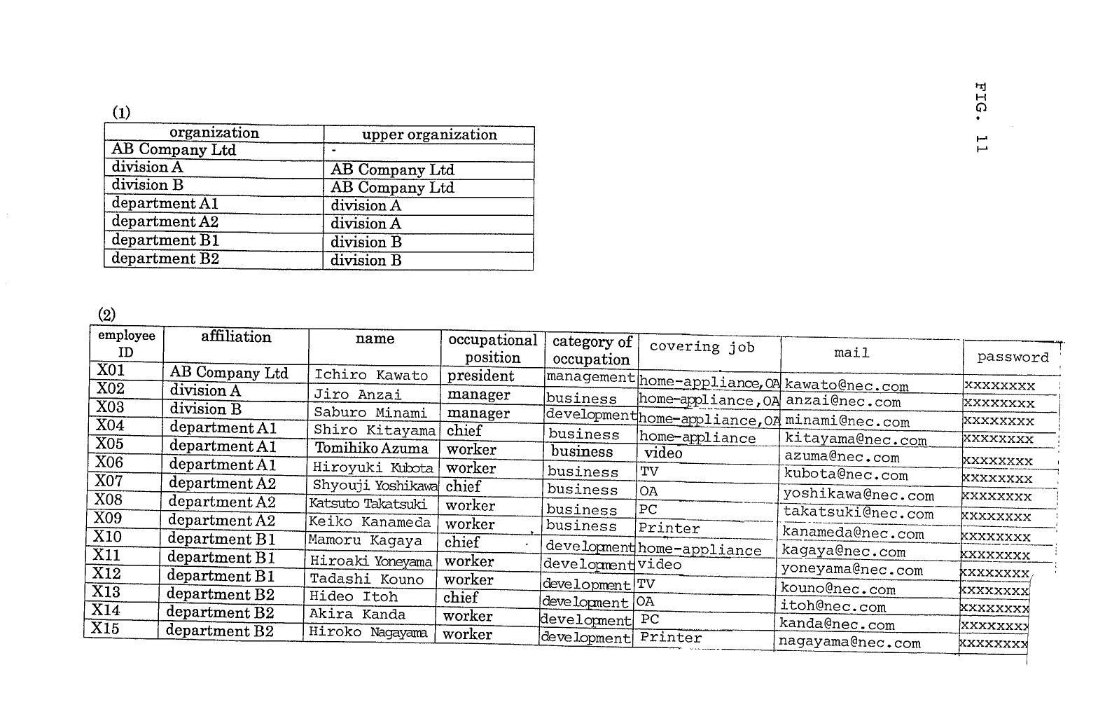

FIG. 11 is an example in which the organization definition information of FIGS. 3 and 4 is represented by the form of a table, such as relational database. Table (1) of FIG. 11 represents the organization construction of “Company AB”, and table (2) represents the distribution of personnel and the personal information.

Now, the description of the operation for distributing a message of an originator to an appropriate recipient on the basis of the organization definition will be provided hereinafter with reference to FIGS. 1, 11, 12, 13, 14, 15, 16, 17, 18, 19 and 20.

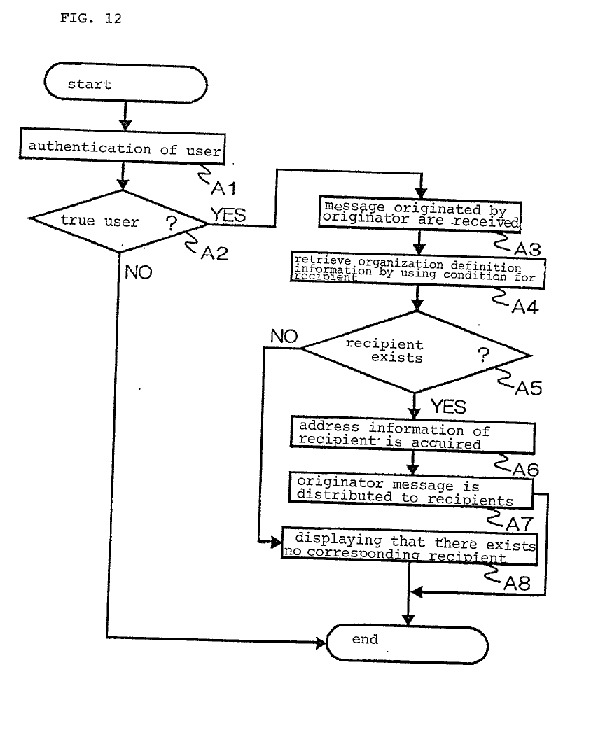

The employee ID and password input from input device 1 are supplied to information-distribution controlling means 22 for authenticating of a user (Step A1 of FIG. 12), and an inspection as to whether or not the user is a true user is executed by utilizing the personal information stored in organization definition information storing means 21 (Step A2). When it is judged that the user is not a true user, the operation is immediately terminated.

When it is confirmed that the user is a true user, the message originated by the originator through input device 1 and a condition for a recipient of message designated by the use of an arbitrary organization definition information stored in organization definition information storing unit 31 are received (Step A3).

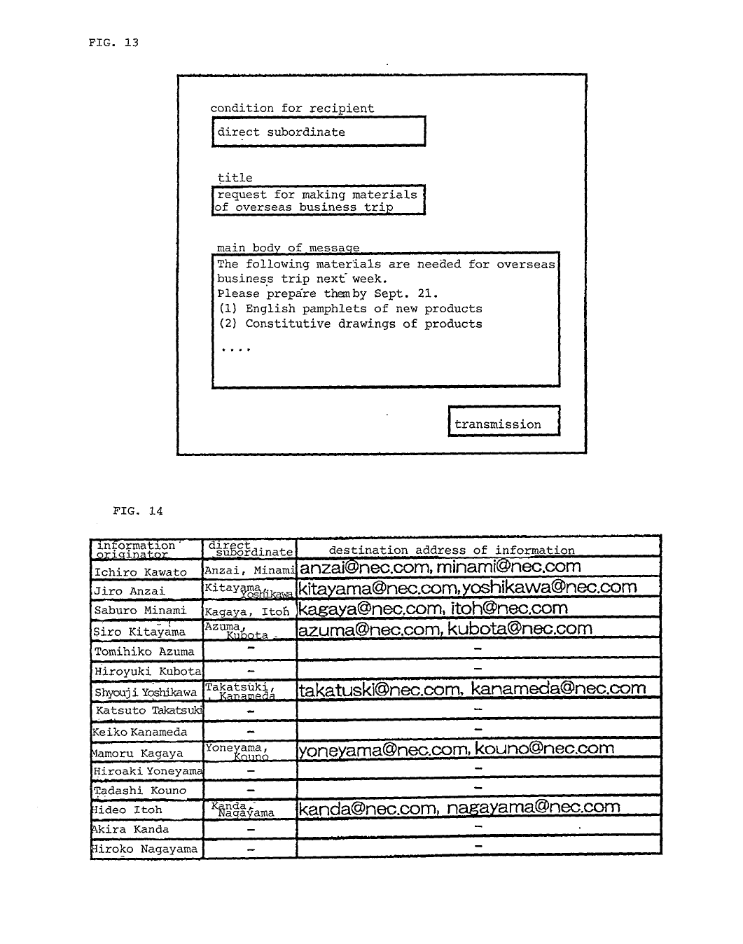

FIG. 13 is an example of a display indicated on output device 4 when the originator executes the origination of information by employing input device 1. In FIG. 13, as the condition for a recipient of a message, “direct subordinate” is designated, and then the title of the message and the text are designated. When the originator of information presses a “transmission” button, the message and the condition for the recipient of message are sent to information-distribution controlling means 22.

Then, information-distribution controlling means 22 retrieves organization definition information storing unit 31 by using the condition for the recipient of message received from input device 1 (Step A4), and inspects whether or not a recipient who satisfies the condition for the recipient of message exists in organization definition information storing unit 31 (Step A5). When a recipient who can satisfy the condition for the recipient of message is detected, address information of the recipient is acquired from organization definition information storing unit 31 (Step A6), and the message is distributed to all of the recipients who can satisfy the condition for the recipient of message (Step A7). When no recipient who satisfies the condition for the recipient of message is founded, displaying of the fact that there exists no corresponding recipient is executed on output device 4 of the originator (Step A8).

Referring to FIG. 11, it is understood that the direct subordinates of “Kawato” who is the president of “Company AB” are “Anzai” who is the manager of “Division A”, and “Minami” who is the manager of “Division B”. Therefore, under a condition such that the organization definition information of FIG. 11 is stored in organization definition information storing unit 31, when “Kawato” who is an information originator, utilizes the displaying of FIG. 13, information-distribution controlling means 22 will detect “Anzai” and “Minami” as recipients who satisfy the condition for recipient of message stating, “direct subordinate”, and distributes the message of “Kawato” to the respective E-mail addresses of “anzai@nec.com” and “minami@nec.com”, respectively.

FIG. 14 is a view for illustrating and explaining the information-distribution controlling, when an employee of “Company AB” executes transmission of information by utilizing the displaying of FIG. 13 under a condition such that the organization definition information of FIG. 11 is stored in organization definition information storing unit 31. The first line in table of FIG. 14 except for the headline indicates that when “Ichiro Kawatou” who is an information originator, designates “direct subordinate” as the condition for recipient of message, information-distribution controlling means 22 detects “Anzai” and “Minami” as recipients who satisfy the condition for recipient of message, and distributes the information to the respective E-mail addresses. Similarly, when “Anzai” designates “direct subordinate” as a condition for recipient of message, and when “Minami” designates “direct subordinate” as a condition for recipient of message, the respective messages are distributed to “Kitayama” and “Yosikawa”, and “Kagaya” and “Itoh”, respectively. The “-” appearing in FIG. 14 indicates that no recipient who can satisfy the condition for recipient of message stating, “direct subordinate” exists in the organization definition information of FIG. 11. For example, when “Higasi” uses, as an information originator, the displaying of FIG. 13, information-distribution controlling means 22 does not carry out the transmission of information for the reason that no direct subordinate of “Higasi” can be detected in organization definition information storing unit 31, and displays on output device 4 the fact that no “direct subordinate” could not be detected for “Higasi”.

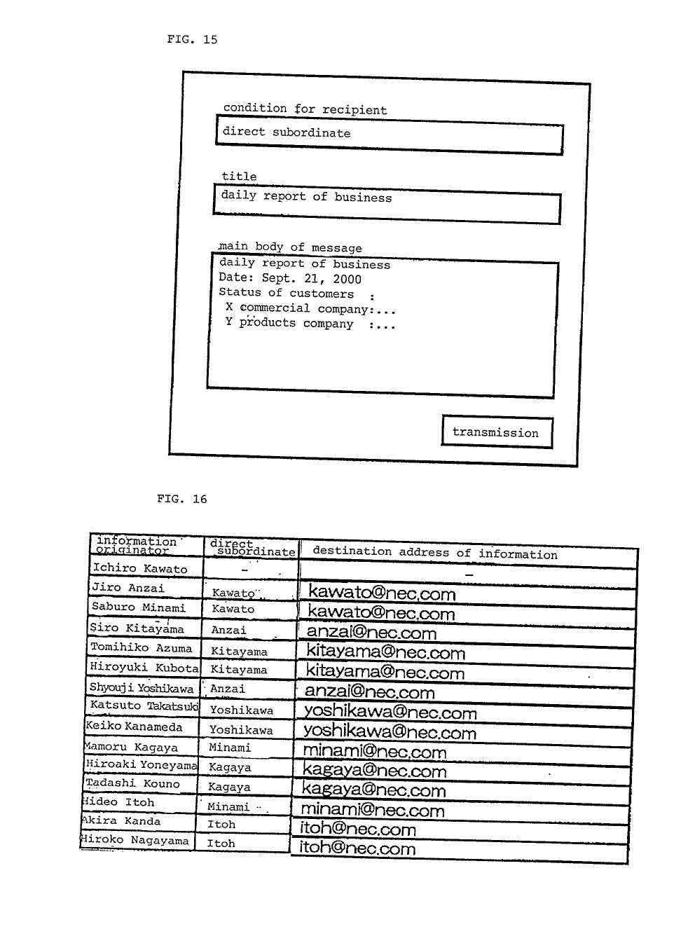

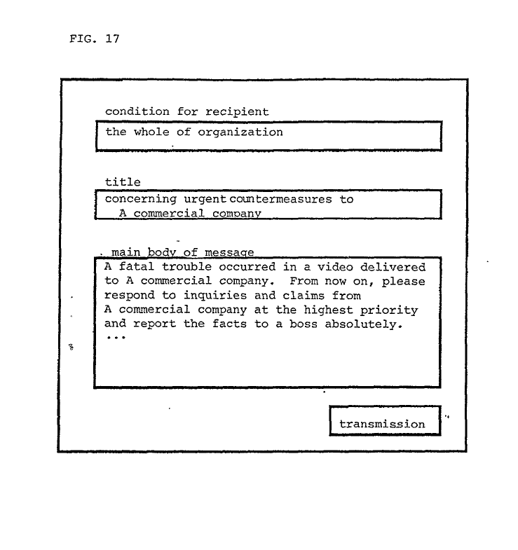

FIGS. 15 and 16 are views for illustrating and explaining an example in which “direct boss” is designated as a condition for recipient of message. More specifically, FIG. 15 is an example of a display appearing on output device 4 when an originator executes transmission of information by the use of input device 1, and “direct boss” is designated as the condition for recipient of message. FIG. 16 is a view for explaining the operation for information-distribution controlling in a case where an employee of “Company AB” executes transmission of information by utilizing the displaying in FIG. 15 under a condition such that the organization definition information of FIG. 11 is stored in organization definition information storing unit 31. The second line of FIG. 16 except for the headline indicates that when “Jiro Anzai” who is an information originator, designates “direct boss” as the condition for recipient of information, information-distribution controlling means 22 detects “Kawato” as a recipient who satisfies the condition for recipient of information, and distributes the information to the E-mail address of “Kawato”. Similarly, when “Kitayama” designates “direct boss” as a condition for recipient of message, and when “Higasi” designates “direct boss” as a condition for recipient of message, the messages are distributed to “Anzai” and “Kitayama”, respectively. In FIG. 16, “-” indicates, similar to FIG. 14, that no recipient who satisfies the condition for recipient of message stating, “direct boss” exists in the organization definition information of FIG. 11.

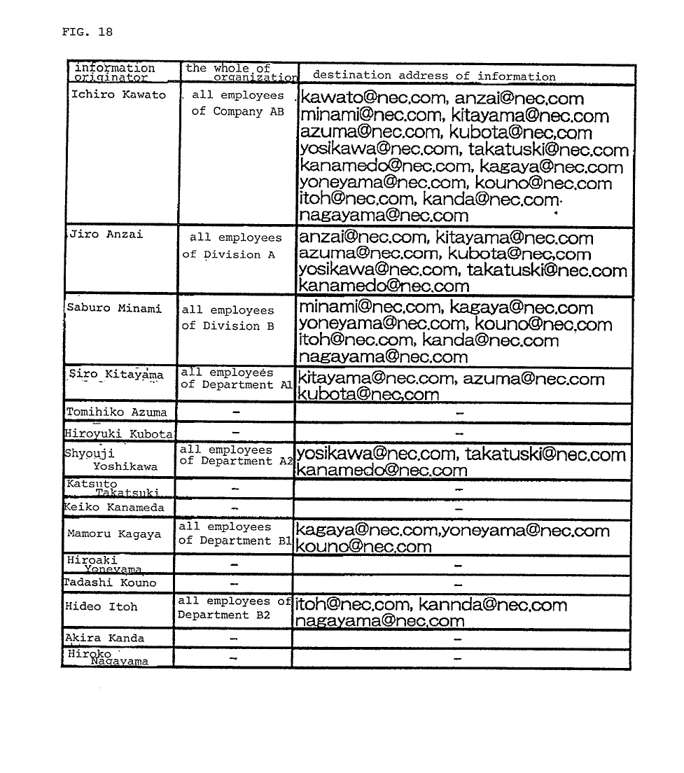

FIGS. 17 and 18 are views for illustrating and explaining an example in which “the whole of organization” is designated as a condition for recipient of message. More specifically, FIG. 17 is an example of a display appearing on output device 4, when an originator executes transmission of information by the use of input device 1, and “the whole of organization” is designated as the condition for recipient of message. Further, FIG. 18 is a view explaining the operation for information-distribution controlling when an employee of “Company AB” executes transmission of information by utilizing the display shown in FIG. 17, under a condition such that the organization definition information of FIG. 11 is stored in organization definition information storing unit 31.

The first line of table of FIG. 18 except for the headline indicates that when “Ichiro Kawato” who is an information originator, designates “the whole of organization” as the condition for recipient of message, information-distribution controlling means 22 will detect “all employees of Company AB” as recipients who satisfy the condition for recipient due to the fact that “Kawato” is the president, and distributes the message to the E-mail addresses of “all employees of Company AB”. Similarly, when “Anzai” designates “the whole of organization” as the condition for recipient of message, the message will be distributed to “all employees in Division A” due to the fact that “Anzai” is the manager of the Division A, and when “Kitayama” designates “the whole of organization” as the condition for recipient of message, the message will be distributed to “all employees of the Department A1” due to the fact that “Kitayama” is the chief of the Department A1. In FIG. 18, “-” indicates, similar to FIG. 14, that no recipient who satisfies the condition for recipient of message stating, “the whole of organization” exists in the organization definition information of FIG. 11.

FIG. 19 illustrates an example in which the attribute of individuals in the organization definition information is utilized as a condition for recipient of message. More specifically, FIG. 19 illustrates an example of a display appearing on output device 4 when an originator executes transmission of information by the use of input device 1, and “occupational position=chief” is designated as the condition for recipient of message. Information-distribution controlling means 22 receives the condition for recipient stating, “occupational position=chief” from input device 1, and retrieves organization definition information storing unit 31 to detect a recipient who satisfies the condition stating, “occupational position=chief”. When the organization definition information of FIG. 11 is stored in organization definition information storing unit 31, Information-distribution controlling means 22 detects “Kitayama”, “Yosikawa”, “Kagaya”, and “Itoh”, and acquires the E-mail addresses of these four persons from organization definition information storing unit 31 to thereby distribute the message of FIG. 19.

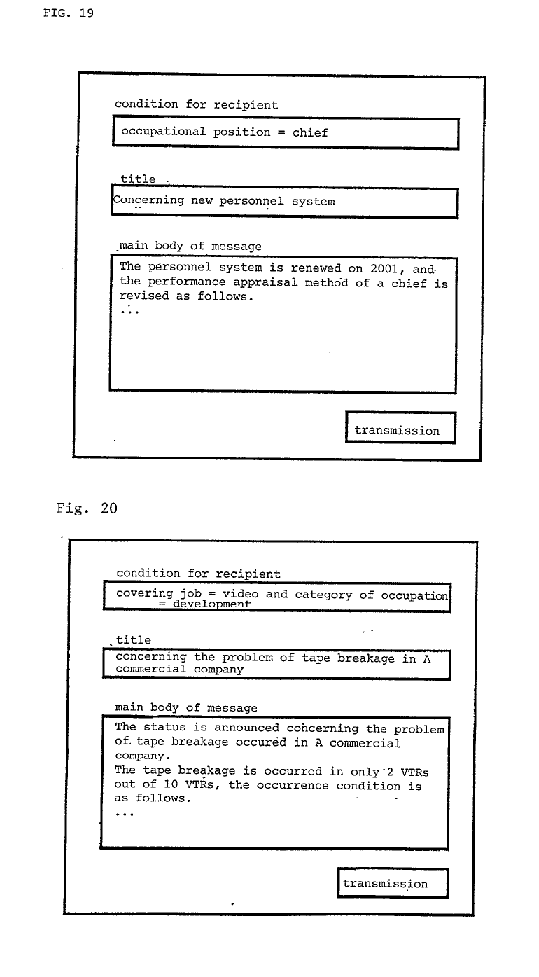

FIG. 20 illustrates an example in which a complex condition using a plurality of attributes of individuals in the organization definition information is designated as a condition for a recipient of message. More specifically, FIG. 20 is an example of a display appearing on output device 4 when an originator executes transmission of information by the use of input device 1, and “covering job=video and category of occupation=development” is designated as the condition for recipient of message. Information-distribution controlling means 22 receives the condition for recipient stating, “covering job=video and category of occupation=development” from input device 1, and retrieves organization definition information storing unit 31 to detect a recipient who satisfies the condition stating, “covering job=video and category of occupation=development”. Information-distribution controlling means 22 detects “Yoneyama” when the organization definition information of FIG. 11 is stored in organization definition information storing unit 31, and acquires the E-mail address of “Yoneyama” from organization definition information storing unit 31 to thereby distribute the message of FIG. 20.

Finally, the operation for the information-distribution controlling will be described for the case where personnel changes and a change in the organization occur, with reference to FIGS. 1, 11, 14, 21, 22 and 23.

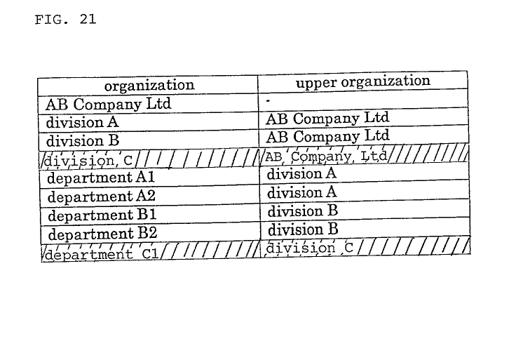

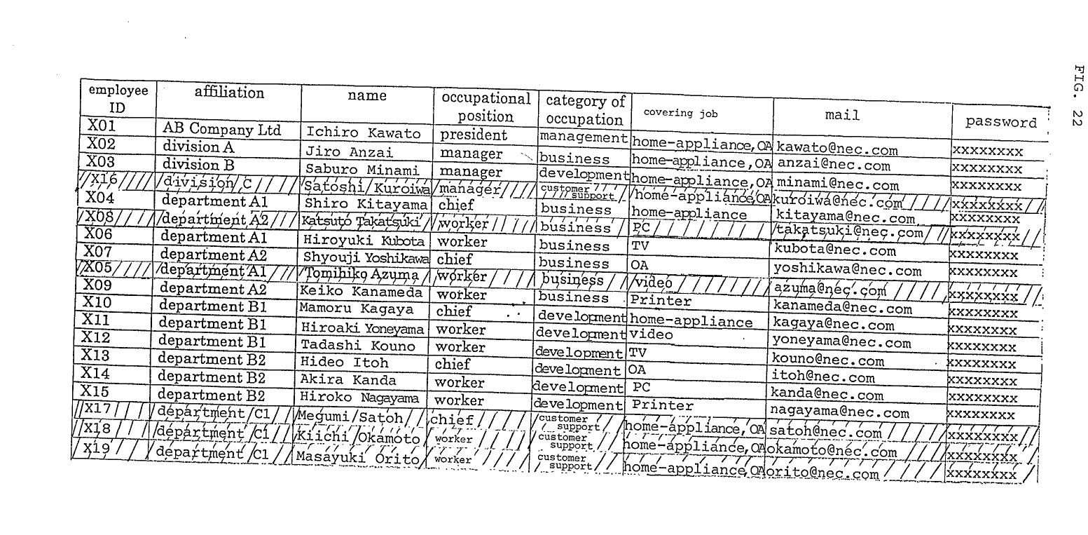

FIGS. 21 and 22 are views indicating a result of the personnel changes and the change in the organization reflected on the organization definition information shown in tables (1) and (2) of FIG. 11. In FIGS. 21 and 22, portions with hatching indicate places changed from those of FIG. 11. Namely, in FIGS. 21 and 22, “Division C” and “Department C” are added to the tables (1) and (2) of FIG. 11, and thus a new manager, a new chief, and new workers are assigned. Further, the affiliation of “Higasi” and that of “Takatuki” are replaced with one another.

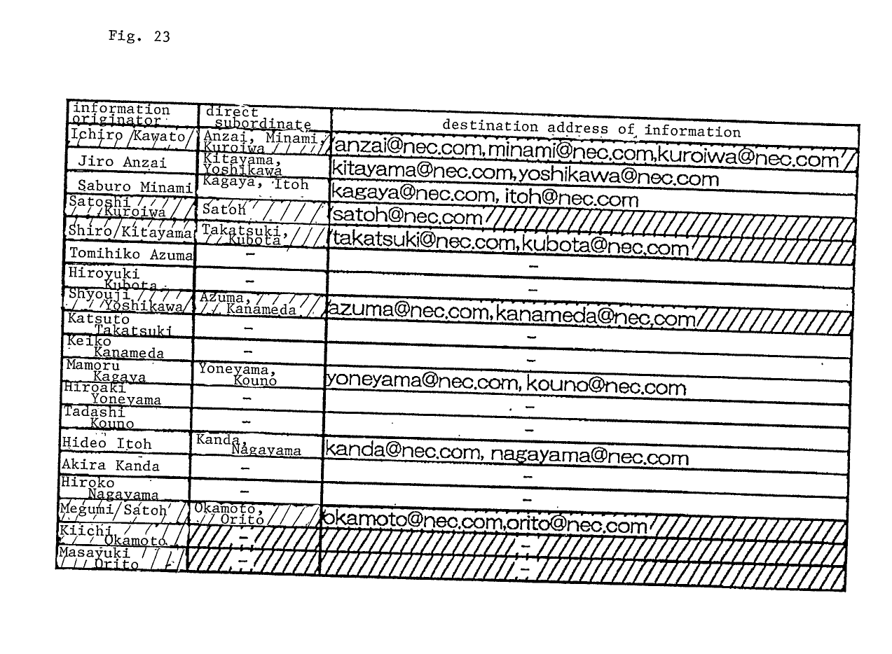

FIG. 23 is a view for explaining the operation for information-distribution controlling which is executed for the new organization definition when “direct subordinates” is designated as a condition for recipient of message. Although portions with hatching in FIG. 23 are those changed from FIG. 14, no particular operation is needed because the information-distribution controlling shown in FIG. 23 is automatically determined by the change in the organization definition information of FIGS. 21 and 22. Accordingly, as soon as the organization definition information shown in FIGS. 21 and 22 is stored in organization definition information storing unit 31, the information-distribution controlling shown in FIG. 23 operates effectively in information-distribution controlling means 22, so that an appropriate information-distribution controlling can be immediately executed according to the new definition of organization.

[The Feature of the Invention]

As described hereinbefore, according to the present invention, since the flow of information in a business information system is controlled and managed by directly utilizing the organization hierarchy, the personnel distribution, and the occupational position and covering job of individuals that are the organization definition information, the present invention provides a business information system whereby an accuracy in the distribution of information in the business information system may be enhanced, and transmission of necessary information to necessary persons is surely enabled at a reduced cost.

The important constituents of the business information system according to the present invention can be summarized below, with reference to FIG. 1. Namely, in FIG. 1, organization definition information registering means 21 receives information such as the organization hierarchy, the personnel distribution, the job definition of individuals that are the organization definition information, and authentication information indicating that an individual is a true user of the business information system, from input device 1, and stores them in organization definition information storing unit 31. Information-distribution controlling means 22 receives authentication information of an originator of information from input device 1, and after confirming that the originator is a true user of the business information system, receives a message originated by the originator via input device 1 and a condition for recipient of message designated by the use of arbitrary organization definition information stored in organization definition information storing unit 31. Information-distribution controlling means 22 retrieves organization definition information storing unit 31 by the use of the condition for recipient of message, and upon detection of the recipient of message, acquires address information of the recipient from organization definition information storing unit 31 to distribute the message. Upon failing of detection of the recipient, displaying of the fact that no corresponding recipient of the message was detected is indicated on output device 4 of the originator.

At this stage, it should be understood that the embodiment of the present invention is not limited to those described hereinabove, and thus changes might be appropriately made by, for example, unifying and/or separating respective constituents of the present invention. Further, programs executed by an information processing apparatus such as an electronic computer, which constitutes the present invention may be distributed via a recording medium capable of being read by the computer and a communication network.

While a preferred embodiment of the present invention has been described using specific terms, such description is for illustrative purposes only, and it is to be understood that changes and variations may be made without departing from the spirit or scope of the following claims.

What is claimed is:

1. A business information system comprising:
an organization definition information storing unit for storing organization definition information for defining an organization;
an organization definition information registering means for storing input organization definition information in said organization definition information storing unit; and
an information-distribution controlling means for receiving a message originated by an input originator and a condition for recipient of message, which is designated by arbitrary organization definition information stored in said organization definition information storing unit, for retrieving said organization definition information storing unit by use of the conditions for recipient of message, and for acquiring, upon detection of a recipient of the message who satisfies the conditions for recipient of message, address information of the recipient from said organization definition information storing unit to thereby distribute the message.

2. The business information system according to claim 1, wherein said information-distribution controlling means retrieves said organization definition information storing unit by use of the condition for recipient of message, and upon failing in detection of the recipient of the message, displays on an output device of the originator that the corresponding recipient does not exist.

3. The business information system according to claim 1, wherein said address information is any one of electronic mail address, telephone number, facsimile number and address.

4. The business information system according to claim 2, wherein said address information is any one of electronic mail address, telephone number, facsimile number and address.

5. The business information system according to claim 1, wherein said organization definition information includes at least one of information representing organization hierarchy, information representing partial organization, information representing distribution of personnel, and information concerning a job of each individual.

6. The business information system according to claim 2, wherein said organization definition information includes at least one of information representing organization hierarchy, information representing partial organization, information representing distribution of personnel, and information concerning a job of each individual.

7. The business information system according to claim 3, wherein said organization definition information includes at least one of information representing organization hierarchy, information representing partial organization, information representing distribution of personnel, and information concerning a job of each individual.

8. The business information system according to claim 4, wherein said organization definition information includes at least one of information representing organization hierarchy, information representing partial organization, information representing distribution of personnel, and information concerning a job of each individual.

9. The business information system according to claim 5, wherein said information concerning a job of each individual includes information representing at least one of employee identification number, name, occupational position, covering job, function, duty, knowledge, experience, and location.

10. The business information system according to claim 6, wherein said information concerning a job of each individual includes information representing at least one of employee identification number, name, occupational position, covering job, function, duty, knowledge, experience, and location.

11. The business information system according to claim 7, wherein said information concerning a job of each individual includes information representing at least one of employee identification number, name, occupational position, covering job, function, duty, knowledge, experience, and location.

12. The business information system according to claim 8, wherein said information concerning a job of each individual includes information representing at least one of employee identification number, name, occupational position, covering job, function, duty, knowledge, experience, and location.

13. The business information system according to claim 1, wherein said organization definition information storing unit stores therein authentication information indicating that each individual is a true user of the business information system, and wherein at least one of said organization definition information registering means and said information-distribution controlling means executes a processing when the user is confirmed as a true user of the business information system on a basis of the input authentication information of the user.

14. The business information system according to claim 2, wherein said organization definition information storing unit stores therein authentication information indicating that each individual is a true user of the business information system, and wherein at least one of said organization definition information registering means and said information-distribution controlling means executes a processing when the user is confirmed as a true user of the business information system on a basis of the input authentication information of the user.

15. The business information system according to claim 3, wherein said organization definition information storing unit stores therein authentication information indicating that each individual is a true user of the business information system, and wherein at least one of said organization definition information registering means and said information-distribution controlling means executes a processing when the user is confirmed as a true user of the business information system on a basis of the input authentication information of the user.

16. The business information system according to claim 5, wherein said organization definition information storing unit stores therein authentication information indicating that each individual is a true user of the business information system, and wherein at least one of said organization definition information registering means and said information-distribution controlling means executes a processing when the user is confirmed as a true user of the business information system on a basis of the input authentication information of the user.

17. The business information system according to claim 9, wherein said organization definition information storing unit stores therein authentication information indicating that each individual is a true user of the business information system, and wherein at least one of said organization definition information registering means and said information-distribution controlling means executes a processing when the user is confirmed as a true user of the business information system on a basis of the input authentication information of the user.

18. The business information system according to claim 1, wherein said condition for recipient of message is capable of being defined by a complex condition made by combining a plurality of conditions.

19. The business information system according to claim 2, wherein said condition for recipient of message is capable of being defined by a complex condition made by combining a plurality of conditions.

20. The business information system according to claim 3, wherein said condition for recipient of message is capable of being defined by a complex condition made by combining a plurality of conditions.

21. The business information system according to claim 5, wherein said condition for recipient of message is capable of being defined by a complex condition made by combining a plurality of conditions.

22. The business information system according to claim 9, wherein said condition for recipient of message is capable of being defined by a complex condition made by combining a plurality of conditions.

23. The business information system according to claim 13, wherein said condition for recipient of message is capable of being defined by a complex condition made by combining a plurality of conditions.

24. A method of managing business information by use of organization definition information storing unit for storing organization definition information for defining an organization, comprising:
an organization definition information registering step for storing input organization definition information in said organization definition information storing unit; and
an information-distribution controlling step for receiving a message originated by an input originator and a condition for recipient of message, which is designated by arbitrary organization definition information stored in said organization definition information storing unit, for retrieving said organization definition information storing unit by use of the condition for recipient of message, and for acquiring, upon detection of a recipient of the message who satisfies the condition for recipient of message, address information of the recipient from said organization definition information storing unit to thereby distribute the message.
